(19) United States
(12) Patent Application Publication
(10) Pub. No.: US 2009/0161076 A1
(43) Pub. Date: Jun. 25, 2009

(54) Projection apparatus

(75) Inventors: Sung-Nan Chen, Hsinchu (TW); Chao-Shun Chen, Hsinchu (TW)

Correspondence Address: Joe McKinney Muncy, PO Box 1364, Fairfax, VA, 22038-1364, US

(73) Assignee: Young Optics Inc.

(21) Appl. No.: 12/004,071

(22) Filed: Dec. 20, 2007

(51) Int. Cl. G03B 21/00

(52) U.S. Cl. 353/31

(57) ABSTRACT

A projection apparatus includes a plurality of light sources, a dichroic prism, a plurality of integrator rods, a light-deflecting optics, a light valve and a projection lens. The dichroic prism is used for forming a combined light beam. The integrator rods are positioned between the light sources and the dichroic prism for homogenizing the light beams prior to their incidence on the dichroic prism. The light-deflecting optics is used for deflecting the combined light beam emerging from the dichroic prism, and the light valve is used for receiving and then modulating the combined light beam deflected by the light-deflecting optics to form an image beam. The projection lens is used for projecting the image beam, and its optical axis is substantially parallel to the longitudinal directions of the integrator rods.

### FIELD OF THE INVENTION

The invention relates to a projection apparatus and, more particularly, to a projection apparatus that is made small in size.

### BACKGROUND OF THE INVENTION

FIG. 9 shows a schematic diagram illustrating a configuration inside a conventional projection apparatus 100. Referring to FIG. 9, a light source 102 is mounted on one side of an integrator rod 104, and a reflector 106 is provided on an end face of the integrator rod 104. A lens 108 is provided near the other end face of the integrator rod 104 to gather the light emerging from the integrator rod 104. A reflector 112 is disposed along the optical axis K of the lens 108 to reflect the light that is guided to be incident thereon by the lens 108 and to have the light be reflected towards the direction of a light valve 114. The light valve 114 is configured to receive and then modulate the light to form an image beam. The projection lens 116 is configured to project the image beam onto a screen (not shown).

Though the above design may provide high light-utilization efficiency for the projection apparatus 100, the horizontal span of its optics layout is too wide to thus fail to further minimize the size of the projection apparatus 100.

### SUMMARY OF THE INVENTION

The invention provides a projection apparatus that is made small in size.

According to an embodiment of the invention, a projection apparatus includes a plurality of light sources, a dichroic prism, a plurality of integrator rods, a light-deflecting optics, a light valve and a projection lens. The light sources emit a plurality of light beams having respective colors and propagation paths, and the dichroic prism guides the plurality of light beams to an identical propagation path so as to form a combined light beam. The integrator rods are positioned between the light sources and the dichroic prism for respectively homogenizing the light beams prior to their incidence on the dichroic prism. Each integrator rod has a light-receiving end adjacent to at least one of the plurality of light sources and a light-exiting end adjacent to the dichroic prism. The light-deflecting optics is used for deflecting the combined light beam emerging from the dichroic prism, and the light valve is used for receiving and then modulating the combined light beam deflected by the light-deflecting optics to form an image beam. The projection lens is used for projecting the image beam from the light valve. The longitudinal directions of the plurality of integrator rods are substantially parallel to the optical axis of the projection lens.

In one embodiment, a condenser lens is provided in the projection apparatus and positioned on the propagation path of the combined light beam between the dichroic prism and the light-deflecting optics or between the dichroic prism and the light valve.

In one embodiment, the integrator rods and the dichroic prism are integrally formed as one piece.

In one embodiment, a gap is formed between each of the plurality of integrator rods and the dichroic prism.

According to another embodiment of the invention, a projection apparatus includes a first, a second and a third light sources, a light-mixing device, a first, a second and a third integrator rods, a light-deflecting optics, a light valve, and a projection lens. The first, second and third light sources are positioned on the same plane for respectively emitting a first, a second and a third light beams having respective colors and propagation paths. The light-mixing device includes a reflective surface, a first dichroic mirror, and a second dichroic mirror. The reflective surface is positioned to reflect the first light beam emitted from the first light source. The first dichroic mirror is configured to transmit the first light beam emitted from the first light source and to reflect the second light beam emitted from the second light source. The second dichroic mirror is configured to transmit the first and the second light beams emitted from the first and the second light sources and to reflect the third light beam emitted from the third light source. The first integrator rod is positioned between the first light source and the reflective surface, the second integrator rod is positioned between the second light source and the first dichroic mirror, and the third integrator rod is positioned between the third light source and the second dichroic mirror. The first, second and third integrator rods have light-receiving ends respectively adjacent to the first, the second and the third light sources and light-exiting ends respectively adjacent to the reflective surface, the first and the second dichroic mirrors. The light-deflecting optics deflects a combined light beam emerging from the light-mixing device, the light valve receives and then modulates the combined light beam deflected by the light-deflecting optics to form an image beam, and the projection lens projects the image beam from the light valve. The longitudinal directions of the plurality of integrator rods are substantially parallel to the optical axis of the projection lens.

According to the embodiments of the invention, since the optical axis of the projection lens is substantially parallel to the longitudinal directions of the integrator rods, the optics layout can be squeezed into a smaller space to effectively reduce the occupied space of optics layout and minimize the size of the projection apparatus. Also, in certain circumstances where a short focal length is sufficient for the projection lens, the longitudinal lengths of the integrator rods may be cut down in proportion to a shortened projection lens to further reduce the occupied space of optics layout. Further, since the integrator rods may be positioned along the same plane, they can be placed in a unitary heat-dissipating element to further decrease the size of the projection apparatus. Besides, when each light source is positioned adjacent to the light-receiving end of an integrator rod, its emitting light are well collected without the need of additional condenser lenses arranged between them.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 shows a projection apparatus according to an embodiment of the invention.

FIG. 2 shows a projection apparatus according to another embodiment of the invention.

FIG. 3 shows a projection apparatus according to another embodiment of the invention.

FIG. 4 shows a projection apparatus according to another embodiment of the invention.

FIG. 5 shows a projection apparatus according to another embodiment of the invention.

FIG. 6 shows a projection apparatus according to another embodiment of the invention.

FIGS. 7 and 8 show embodiments of integrator rod coupled to a dichroic prism.

FIG. 9 shows a schematic diagram illustrating a configuration inside a conventional projection apparatus.

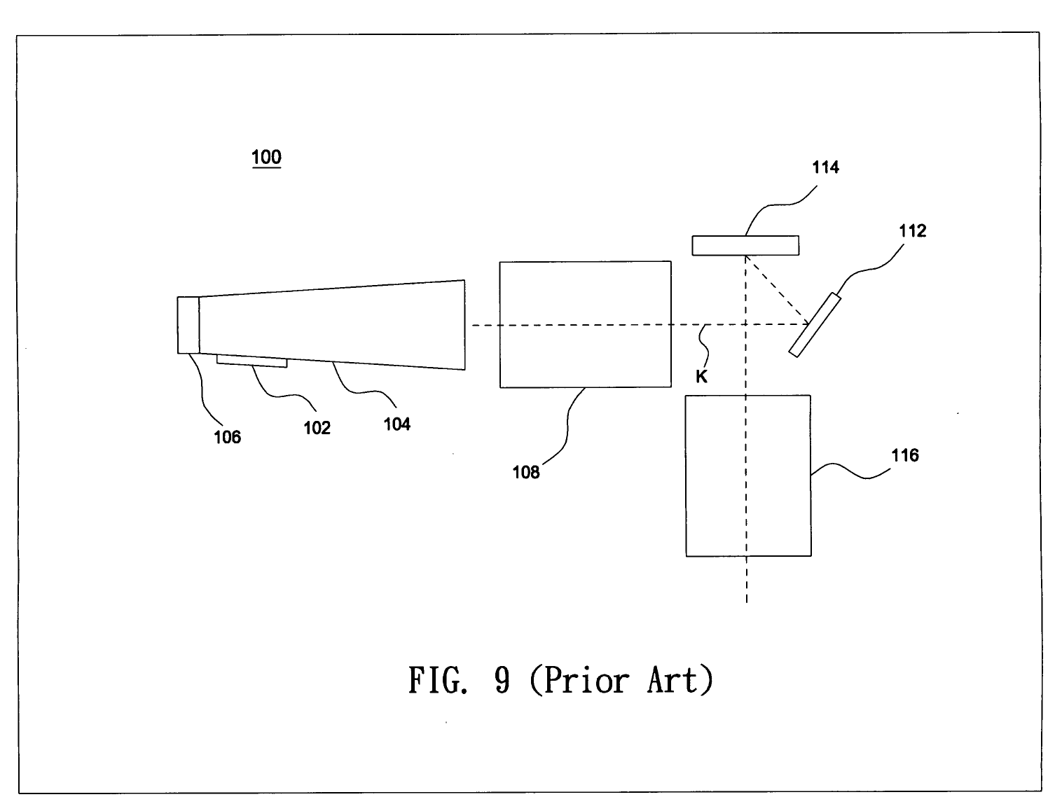

### DETAILED DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and variations thereof herein are used broadly and encompass direct and indirect connections, couplings, and mountings. Similarly, “adjacent to” and variations thereof herein are used broadly and encompass directly and indirectly “adjacent to”. Therefore, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

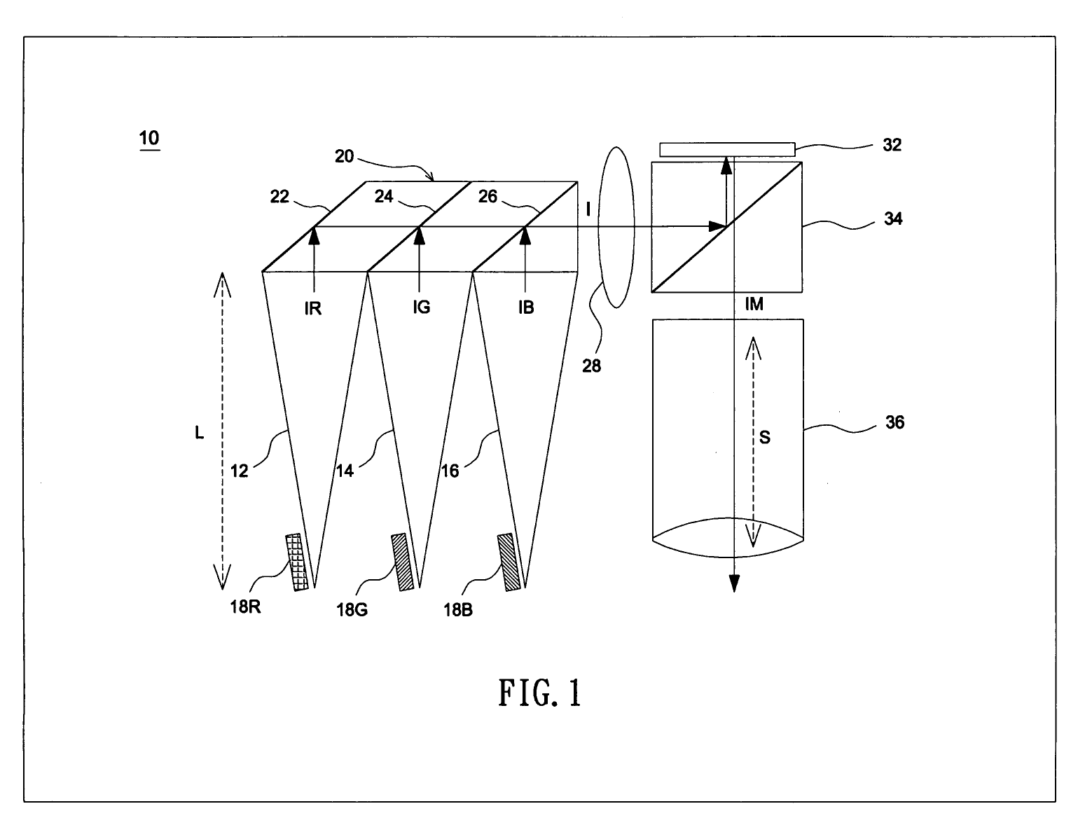

FIG. 1 shows a projection apparatus 10 according to an embodiment of the invention. Referring to FIG. 1, three integrator rods 12, 14 and 16 in the shape of a pyramid are arranged side by side with their longitudinal directions L parallel with each other. A red LED 18R, a green LED 18G and a blue LED 18B (collectively referred to herein as LEDs 18) are positioned adjacent to the sharp ends of the integrator rods 12, 14 and 16, respectively. Further, since the integrator rods 12, 14 and 16 are aligned in a row, they can be placed in a unitary heat-dissipating element such as a heat sink (not shown). A dichroic prism 20, which is used for guiding emitting light beams of the LEDs 18 to an identical propagation path so as to form a combined light beam I, is connected to the integrator rods 12, 14 and 16 via the bottom faces of the pyramids. The dichroic prism 20 has three dichroic mirrors 22, 24, and 26 that are arranged in parallel at regular intervals.

The red LED 18R, the green LED 18G, and the blue LED 18B respectively emit red light beam IR, green light beam IG, and blue light beam IB that propagate in their respective paths, which then enter the integrator rods 12, 14 and 16 by their light-receiving ends (sharp ends of pyramids). The integrator rods 12, 14 and 16 homogenize the light beams of different colors, and the homogenized light beams leave the integrator rods 12, 14 and 16 by their light-exiting ends (flat ends of pyramids) and enter the dichroic prism 20 afterwards.

In the configuration of the dichroic prism 20, the dichroic mirror 22 reflects the red light beam IR, the dichroic mirror 24 is transparent to the red light beam IR and reflects the green light beam IG, and the dichroic mirror 26 is transparent to both the green light beam IG and the red light beam IR and reflects the blue light beam IB. In operation, prior to being gathered by a condenser lens 28, the red light beam IR is reflected by the dichroic mirror 22 and passes through both the dichroic mirror 24 and the dichroic mirror 26, the green light beam IG is reflected by the dichroic mirror 24 and passes through the dichroic mirror 26, and the blue light beam IB emitted by LED 18B is reflected by the dichroic mirror 26. Of course, if the order of LEDs 18 is arranged differently, other combinations of dichroic mirrors may be used. The condenser lens 28 gathers the combined light beam I emerging from the dichroic prism 20 to a polarized beam splitter (PBS) prism 34. While the condenser lens 28 is illustrated as a single lens element, the condenser lens 28 may be made up of a plurality of lens elements. The PBS prism 34 is configured to reflect the combined light beam I that is guided to be incident thereon by the condenser lens 28 and makes the combined light beam I be reflected towards the direction of the light valve 32. The light valve 32 is configured to receive and then modulate the combined light beam I reflected by the PBS prism 34 to form an image beam IM. For instance, the light valve 32 may be a digital micro mirror device (DMD) or a liquid crystal on silicon (LCOS) panel. The projection lens 36 is configured to project the image beam IM onto a screen (not shown). The optical axis S of the projection lens 36 is substantially parallel to the longitudinal directions L of the integrator rods 12, 14, and 16. Though the projection lens 36 is illustrated as a single lens element, it may be made up of a plurality of lens elements.

According to the embodiment, since the optical axis S of the projection lens 36 is substantially parallel to the longitudinal directions of the integrator rods 12, 14 and 16, the occupied space of optics layout can be effectively reduced to minimize the size of the projection apparatus 10. Also, in certain circumstances where a short focal length is sufficient for the projection lens 36, the longitudinal lengths of the integrator rods 12, 14 and 16 may be cut down in proportion to a shortened projection lens 36 to further reduce the occupied space of optics layout. Further, since the integrator rods 12, 14 and 16 are positioned on the same plane, they can be placed in a unitary heat-dissipating element to further decrease the size of the projection apparatus 10. Besides, when each of the LEDs 18 is positioned adjacent to the light-receiving end of an integrator rod, the emitting light of LEDs 18 are well collected without the need of additional condenser lenses arranged between them.

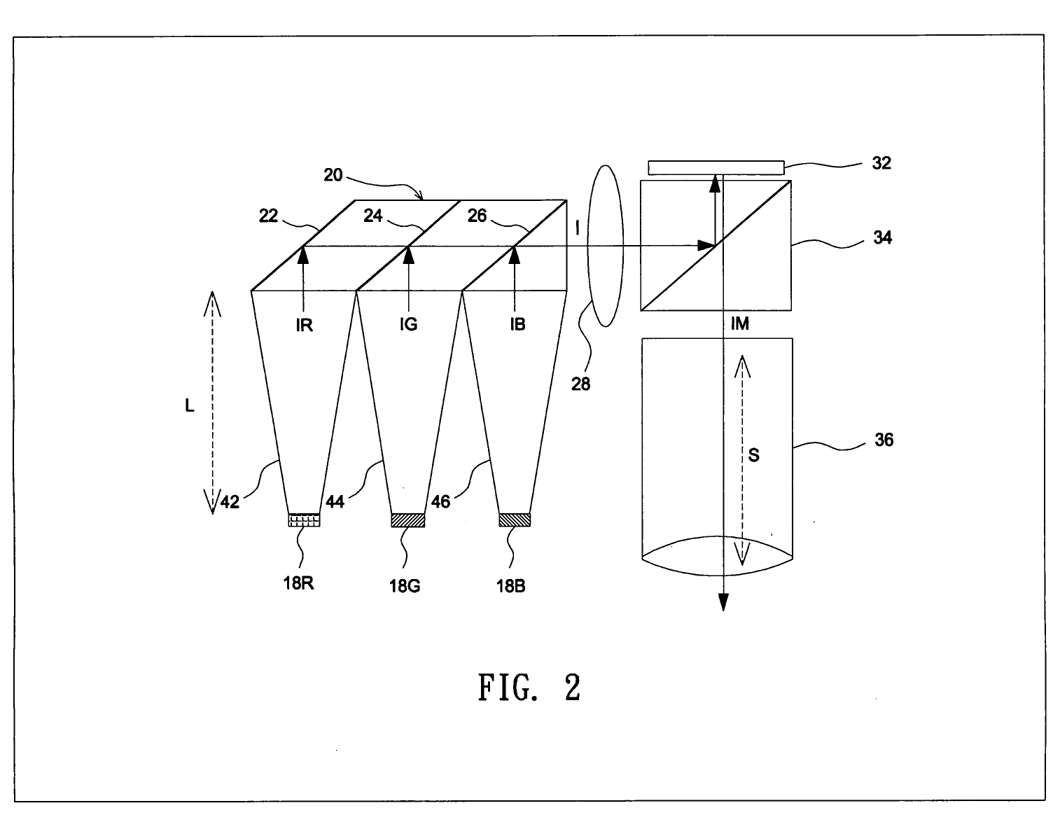

Note that the shape, material, and size of the integrator rods 12, 14 and 16 are not limited, as long as they may well homogenize incoming light beams. Referring to FIG. 2, the embodiment is similar to that shown in FIG. 1, except that the integrator rods 42, 44 and 46 are in the shape of a pyramid frustum, and that the LEDs 18 are mounted on flat surfaces formed on the tips of the integrator rods 42, 44 and 46. This ensures the emitting light beams of the LEDs 18 may enter the integrator rods 42, 44 and 46 as possible.

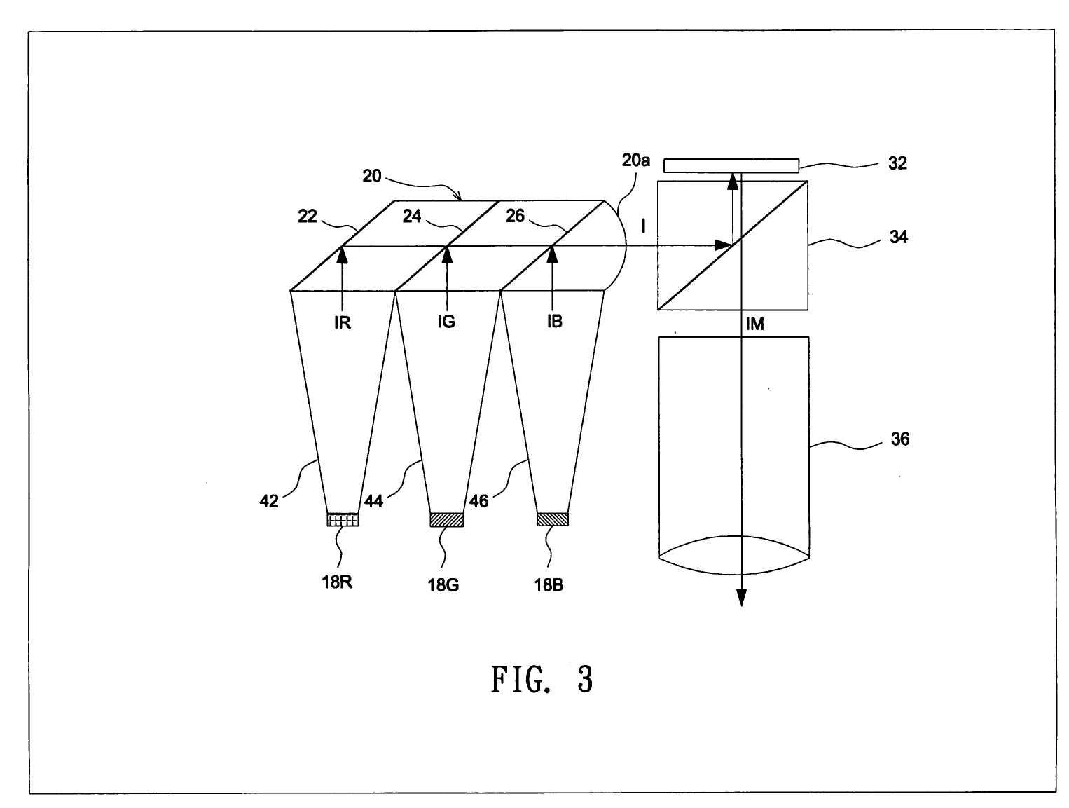

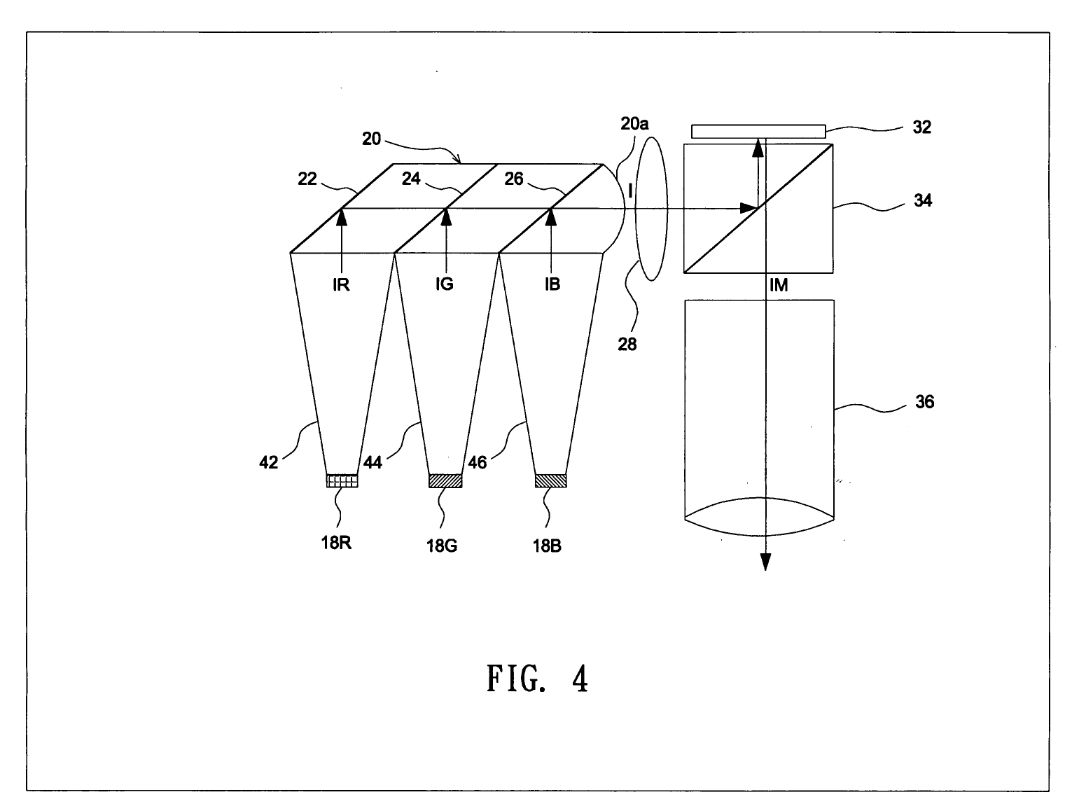

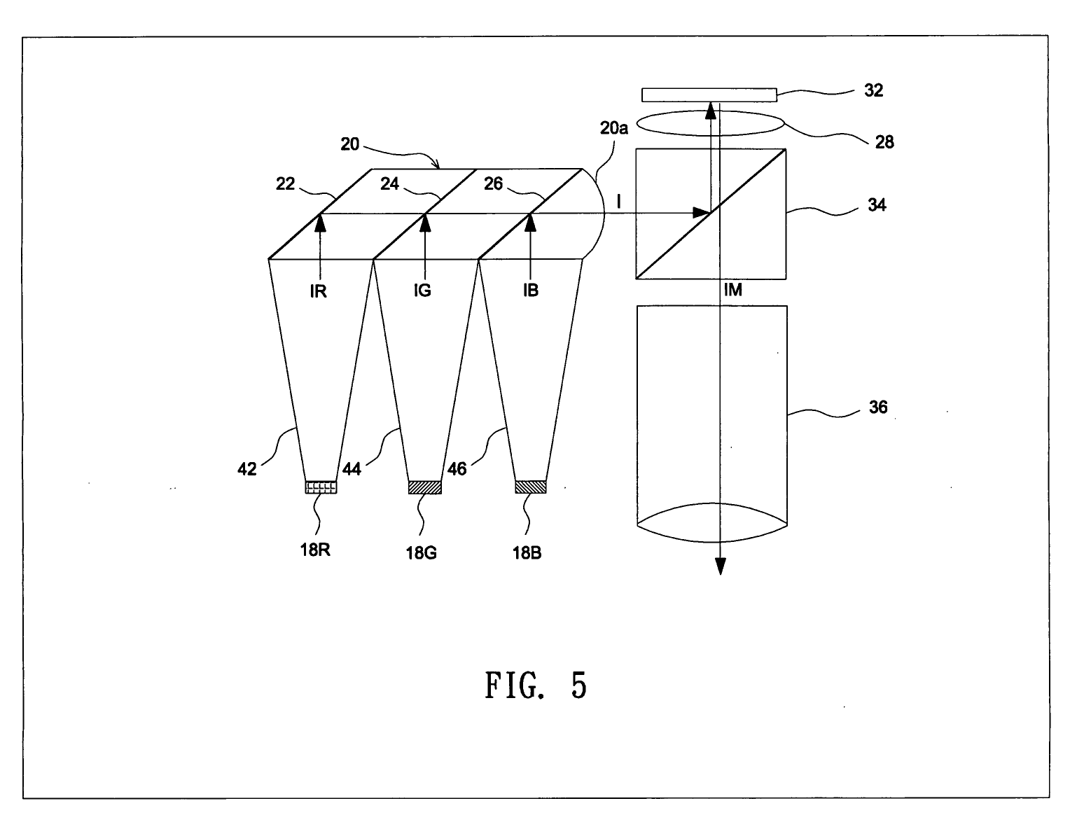

Referring to FIG. 3, the light-exiting surface 20a of the dichroic prism 20 is formed as a convex surface that is pointed toward the PBS prism, so that the convex side of the dichroic prism 20 may function as a condenser and substitute for the condenser lens 28 shown in FIG. 2. In an alternative embodiment, the condenser lens 28 and the convex side of the dichroic prism 20 may co-exist to allow for an more improved light collection, and, in that case, the condenser lens 28 may be positioned in the light path between the dichroic prism 20 and the PBS prism 34 (FIG. 4) or between the PBS prism 34 and the light valve 32 (FIG. 5).

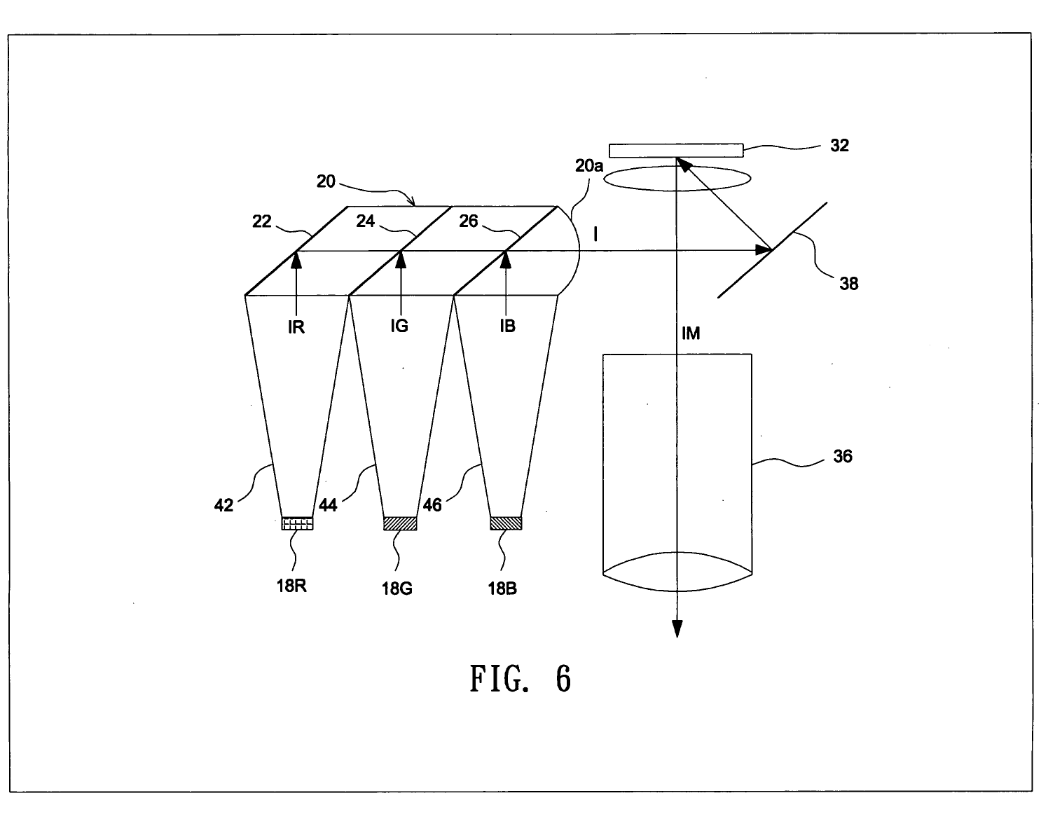

As shown in FIG. 6, in one embodiment, the light-deflecting optics that guides the combined light beam I emerging from the dichroic prism 20 towards the direction of the light valve 32 is a reflective mirror 38 instead of the PBS prism 34. Note that the PBS prism 34 and the reflective mirror 38 are illustrated as examples, and other light-deflecting optics such as a total internal reflection (TIR) prism can be used for deflecting light.

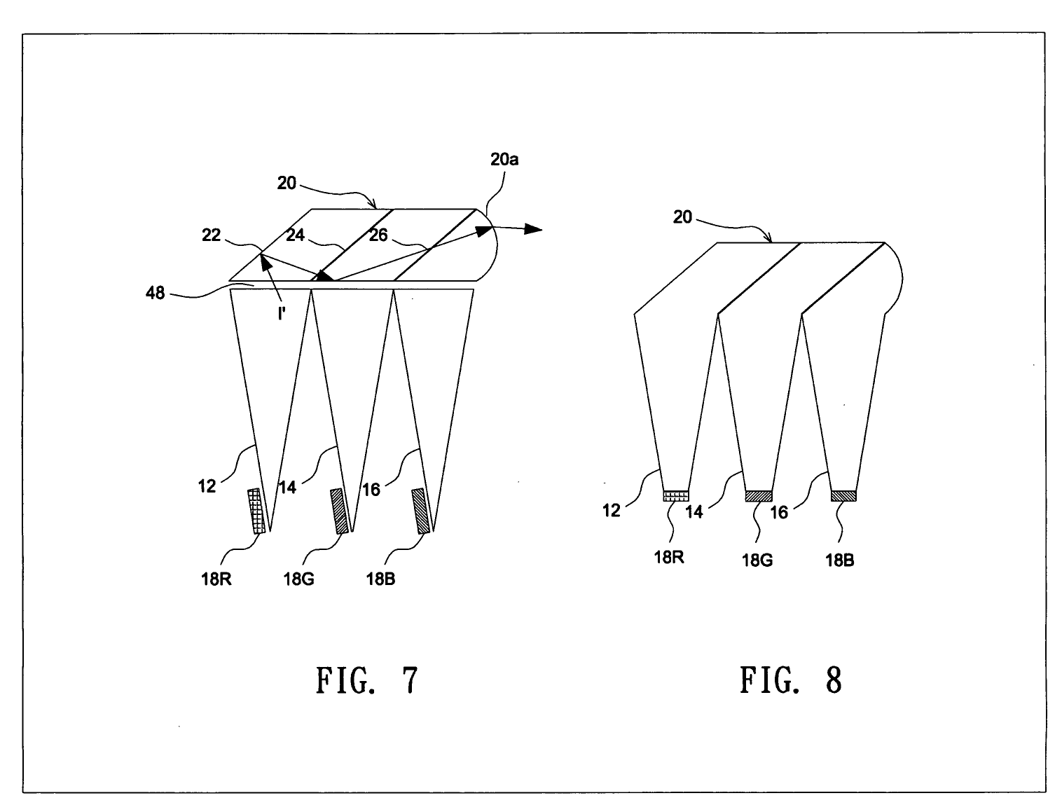

FIGS. 7 and 8 show other embodiments of an integrator rod coupled to a dichroic prism. Referring to FIG. 7, the integrator rods 12, 14, and 16 and the dichroic prism 20 are so positioned that a small gap 48 is formed between them. Through such arrangement, total internal reflection takes place at the boundary between the prism and the gap to allow some light beams I′ that strike the dichroic mirror at an improper angle of incidence to be reflected back to the dichroic prism 20 and still gathered by the condenser lens (such as the convex side 20a of the dichroic prism 20). This configuration further increases the quantity of light transmitted to the light valve 32.

Further, all the integrator rods 12, 14, and 16 and the dichroic prism 20 may be integrally formed as one piece, such as shown in FIG. 8.

Note that, according the above embodiments, the intended use of the left-most dichroic mirror 22 is to reflect incoming light but not completely filter out specific wavelength bands of light. Therefore, the left-most dichroic mirror 22 may be replaced with a reflective mirror to equally transmit the red light IR towards the light-deflecting optics.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus, comprising:
a plurality of light sources for emitting a plurality of light beams having respective colors and propagation paths;
a dichroic prism for guiding the plurality of light beams to an identical propagation path so as to form a combined light beam;
a plurality of integrator rods positioned between the light sources and the dichroic prism for respectively homogenizing the plurality of light beams prior to their incidence on the dichroic prism, wherein each of the plurality of integrator rods has a light-receiving end adjacent to at least one of the plurality of light sources and a light-exiting end adjacent to the dichroic prism;
a light-deflecting optics for deflecting the combined light beam emerging from the dichroic prism;
a light valve for receiving and then modulating the combined light beam deflected by the light-deflecting optics to form an image beam; and
a projection lens for projecting the image beam from the light valve;
wherein the longitudinal directions of the plurality of integrator rods are substantially parallel to the optical axis of the projection lens.

2. The projection apparatus as claimed in claim 1, further comprising a condenser lens positioned on the propagation path of the combined light beam between the dichroic prism and the light-deflecting optics.

3. The projection apparatus as claimed in claim 1, wherein the plurality of light sources comprise a red light-emitting diode (LED), a green LED, and a blue LED.

4. The projection apparatus as claimed in claim 1, wherein the dichroic prism comprises a plurality of dichroic mirrors arranged in parallel at regular intervals.

5. The projection apparatus as claimed in claim 1, wherein the plurality of integrator rods are in the shape of a pyramid.

6. The projection apparatus, as claimed in claim 1, wherein the light-deflecting optics is a polarized beam splitter (PBS) prism, a total internal reflection (TIR) prism, or a reflective mirror.

7. The projection apparatus as claimed in claim 1, wherein the light valve is a digital micro mirror device (DMD) or a liquid crystal on silicon (LCOS) panel.

8. The projection apparatus as claimed in claim 1, wherein the dichroic prism has a convex side pointed toward the light-deflecting optics.

9. The projection apparatus as claimed in claim 8, further comprising a condenser lens positioned on the propagation path of the combined light beam between the dichroic prism and the light-deflecting optics or between the dichroic prism and the light valve.

10. The projection apparatus as claimed in claim 1, wherein the plurality of integrator rods are connected to one side of the dichroic prism.

11. The projection apparatus as claimed in claim 1, wherein a gap is formed between each of the plurality of integrator rods and the dichroic prism.

12. The projection apparatus as claimed in claim 1, wherein the light sources are respectively mounted on the integrator rods.

13. The projection apparatus as claimed in claim 1, wherein the integrator rods and the dichroic prism are integrally formed as one piece.

14. A projection apparatus, comprising:
a first, a second and a third light sources positioned on the same plane for respectively emitting a first, a second and a third light beams having respective colors and propagation paths;
a light-mixing device for guiding the first, the second and the third light beams to an identical propagation path so as to form a combined light beam, wherein the light-mixing device comprises:
a reflective surface positioned to reflect the first light beam emitted from the first light source;
a first dichroic mirror configured to transmit the first light beam emitted from the first light source and to reflect the second light beam emitted from the second light source; and
a second dichroic mirror configured to transmit the first and the second light beams emitted from the first and the second light sources and to reflect the third light beam emitted from the third light source;
a first, a second and a third integrator rods respectively positioned between the first light source and the reflective surface, between the second light source and the first dichroic mirror, and between the third light source and the second dichroic mirror for respectively homogenizing the first, the second and the third light beams prior to their incidence on the reflective surface and the first and the second dichroic mirrors, wherein the first, the second and the third integrator rods have light-receiving ends respectively adjacent to the first, the second and the third light sources and light-exiting ends respectively adjacent to the reflective surface, the first and the second dichroic mirrors;
a light-deflecting optics for deflecting the combined light beam emerging from the light-mixing device;
a light valve for receiving and then modulating the combined light beam deflected by the light-deflecting optics to form an image beam; and
a projection lens for projecting the image beam from the light valve;
wherein the longitudinal directions of the first, the second and the third integrator rods are substantially parallel to the optical axis of the projection lens.

15. The projection apparatus as claimed in claim 14, further comprising a condenser lens positioned on the propagation path of the combined light beam between the light-mixing device and the light deflecting optics.

16. The projection apparatus as claimed in claim 14, wherein the reflective surface and the first and the second dichroic mirrors are formed at regular intervals in a prism, and the prism has a convex side pointed toward the light-deflecting optics.

17. The projection apparatus as claimed in claim 16, further comprising a condenser lens positioned on the propagation path of the combined light beam between the prism and the light-deflecting optics or between the prism and the light valve.

18. The projection apparatus as claimed in claim 16, wherein the first, the second and the third integrator rods are connected to one side of the prism.

19. The projection apparatus as claimed in claim 16, wherein a gap is formed between each of the first, the second and the third integrator rods and the prism.

20. The projection apparatus as claimed in claim 16, wherein the first, the second and the third integrator rods and the prism are integrally formed as one piece.
